(19) United States
(12) Patent Application Publication
(10) Pub. No.: US 2010/0006214 A1
(43) Pub. Date: Jan. 14, 2010

(54) METHOD FOR PRODUCTION OF TRANSPARENT, HEAT-RESISTANT, OIL-RESISTANT LAMINATE NAME PLATE COMPRISING POLYETHYLENE TEREPHTHALATE

(75) Inventors: Takashi Fujimaki, Yokohama-shi (JP); Kiyohiko Yamada, Chuo-ku (JP)

Correspondence Address: SUGHRUE MION, PLLC, 2100 PENNSYLVANIA AVENUE, N.W., SUITE 800, WASHINGTON, DC, 20037, US

(73) Assignee: FTEX INCORPORATED, Yokohama-shi,Kanagawa (JP)

(21) Appl. No.: 12/443,923

(22) PCT Filed: Oct. 2, 2007
(86) PCT No.: PCT/JP2007/069313

§ 371 Date: May 1, 2009

(30) Foreign Application Priority Data
Oct. 2, 2006 (JP) 2006-294865

(51) Int. Cl. B32B 37/06; B32B 37/12

(52) U.S. Cl. 156/244.12; 156/308.2

(57) ABSTRACT

Provided is a method of producing a transparent, heat-resistant, oil-resistant laminate name tag, which includes the steps of laminating a newly developed heat-resistant, oil-resistant polyethylene terephthalate (PET) resin and a adhesive polyolefin resin on each other to form a pouch film including a two-resin three-layered film (F), sandwiching a printed article (L4) having a moisture evaporation rate of 3% or less between the pouch films, and welding the resulting product by heating, in which the two-resin three-layered film (F) is formed of, from the outside: a first layer including a transparent, heat-resistant, stretched polyester film (L1); a second layer including a heat-resistant, oil-resistant, adhesive polyester film (L2); and a third layer including an adhesive polyolefin film (L3).

### TECHNICAL FIELD

The present invention relates to a method of producing a transparent, heat-resistant, oil-resistant polyethylene terephthalate laminate name tag (signs).

### BACKGROUND ART

Up to now, laminating pouch films have been routinely used in large amounts for protecting surfaces of and improving the beauty of various cards, calling cards, season tickets, patient registration cards, photographs, notices, shop menus, instruction manuals, signboards, and the like. Normally, the above printed articles are inserted between two transparent films having one side welded by heating and having a thickness of 100 μm, 150 μm, 250 μm, or the like and the films are passed through a laminater heated to 100 to 150° C., whereby an intended product is obtained. Laminating pouch films of sizes ranging from 57×82 mm for ID cards to 430×604 mm for A2 sheet size, for example, are presently used.

In general, general-purpose laminating pouch films are called pouch film and have a two-layered structure or a three-layered structure. In a two-layered structure, as an outside layer, a transparent, heat-resistant, biaxially stretched polyethylene terephthalate (O-PET) film, which has a heat resistance to 200° C., is used to play the role of surface protection. As an inner side layer, an ethylene vinyl acetate copolymer (EVA) film for low-temperature melting is used to play a role of adhering with printed natural paper. In addition, in a three-layered structure, as an intermediated layer, a low-density polyethylene (LDPE) film for mid-temperature melting is further provided to play the role of auxiliary for interlaminar bonding and low cost. In addition to these laminating pouch films, there is also a laminating pouch film using a polypropylene (PP) film in an outside layer as a special-purpose product.

The inventors of the present invention have previously proposed a method of producing a heat adhesive film and laminate formed of a polyethylene terephthalate (PET) polyester. The inventors proposed a laminate formed of a 12 to 15 μm thin biaxially stretched polyethylene terephthalate (O-PET) film and a heat adhesive PET film modified with an epoxy-based low-molecular-weight type binder and a catalyst for a PET raw material, and a laminate formed of an O-PET film and a heat adhesive film made from PET and polyolefin and modified with an epoxy-based low-molecular-weight type binder and a catalyst. However, the binder as a main component of a modifier was a low-molecular-weight type liquid binder, so gelling or fish eyes (FE) caused by heterogeneous reactions were generated as by-products in long-term production of the heat adhesive film by a reactive extrusion method operations, in some cases. In addition, there was no particular application related to any of the characteristic of that invention.

Patent Document 1: JP 2004-151176 A

### DISCLOSURE OF THE INVENTION

### Problems to be Solved by the Invention

A problem to be solved by the present invention is to provide a laminating pouch film having heat resistance of 150° C. or higher and oil resistance, and a name tag using the same.

In general, metal parts used in the automobile industry or the like are produced with a cutting lubricant applied and put in hundreds to thousands of basket-type containers according to the kinds of part. Then, the parts are degreased with name tags attached to the containers, and delivered to respective processes after degreasing according to a program. However, in recent years, as a novel degreasing wash method, a degreasing method using a paraffin-based oil as a detergent free from air pollution has been developed. The transparent, heat-resistant, oil-resistant laminate name tag of the present invention is aimed at maintaining the shape thereof without causing delamination or large deformation, even after undergoing the steps of being immersed in a paraffin-based washing tank with the metal basket in which the metal parts with the cutting lubricant adhered, are placed, at 60° C. for 10 minutes; and then being subjected to a degreasing process in a vacuum furnace at 140 to 150° C. for 5 minutes.

Commercially available laminating pouch films may not have a heat resistance of 150° C. or higher. The reason may be that the melting points of the constitutional elements of the heat adhesive films are: EVA, about 80 to 100° C.; LDPE, about 100 to 120° C.; and PP, about 160 to 170° C., and the heat deformation temperatures are lower than the melting points by as much as about 10 to 20° C. Thus, the commercially available laminating pouch film does not have a heat resistance at 150° C. or higher.

In particular, the commercially available laminating pouch films do not have oil resistance to paraffin-based detergents, which is a problem to be solved by the present invention, because those resins have qualities analogous to paraffin. On the other hand, O-PET as a surface protection film has a melting point of about 250° C. and a heat resistance of 200° C. In addition, O-PET is a polyester having qualities different from paraffin thereby has an oil resistance. Accordingly, O-PET complies with such objects as the heat adhesive film of the present invention having a heat resistance of 150° C. or higher and an oil resistance.

### Means for Solving the Problems

In other words, it is an object of the present invention to provide the following matters constituting the invention.

First, there is provided a method of producing a transparent, heat-resistant, oil-resistant polyethylene terephthalate laminate name tag, including: sandwiching a printed article (L4) forming a center layer between pouch films; and welding the resulting product by heating, in which: the pouch films each include a three-resin three-layered film (F) formed of, from the outside: a first layer including a transparent, heat-resistant, stretched polyester film (L1); a second layer including a heat-resistant, oil-resistant, adhesive polyester film (L2) formed of a heat-resistant, oil-resistant polyethylene terephthalate resin, which is obtained by a homogeneous reaction at temperature of 250° C. or higher of a mixture formed of (A) 100 parts by weight of a polyethylene terephthalate polyester, (B) 0.05 to 2 parts by weight of a polymer polyfunctional epoxy compound as a binder, in which a molecular weight of a skeleton resin is 1,000 to 300,000 and the skeleton resin contains 5 to 100 epoxy groups in the molecule, (C) 0.1 to 1 part by weight of a metal salt of an organic acid as a binding reaction catalyst, (D) 0 to 50 parts by weight of a polycondensate of ethylene glycol/cyclohexanedimethanol/terephthalic acid (PETG), and (E) 0 to 50 parts by weight of a polyester elastomer; and a third layer including a adhesive polyolefin film (L3); and the pouch films are each formed by superimposing two three-resin three-layered films (F) in a manner that each of the layers (L3) face each other.

Second, there is provided a method of producing a transparent, heat-resistant, oil-resistant polyethylene terephthalate laminate name tag, in which the transparent, heat-resistant, stretched polyester film (L1) includes a biaxially stretched polyethylene terephthalate film having a thickness of 30 to 150 μm and a crystallinity index of 20% or more.

Third, there is provided a method of producing a transparent, heat-resistant, oil-resistant polyethylene terephthalate laminate name tag, in which the heat-resistant, oil-resistant, adhesive polyester film (L2) includes a laminate film formed by extrusion-molding a heat-resistant, oil-resistant polyethylene terephthalate resin with a casting method at 250 to 300° C., the heat-resistant, oil-resistant polyethylene terephthalate resin being obtained by a homogeneous reaction of a mixture with a reactive extrusion method at a temperature of 250° C. to 300° C. and having MFR of 50 g/10 min or less in accordance with a JIS method at 280° C., under a load of 2.16 Kg, the mixture being formed of (A) 100 parts by weight of a recycled or new polyethylene terephthalate polyester, (B) 0.05 to 2 parts by weight of a polymer polyfunctional epoxy compound as a binder, in which a molecular weight of a skeleton resin is 1,000 to 300,000 and the skeleton resin contains 5 to 100 epoxy groups in the molecule, (C) 0.1 to 1 part by weight of a stearate of an alkali metal and an alkaline earth metal as a binding reaction catalyst, (D) 0 to 50 parts by weight of a polycondensate of ethylene glycol/cyclohexanedimethanol/terephthalic acid, and (E) 0 to 50 parts by weight of a polyester elastomer.

Fourth, there is provided a method of producing a transparent, heat-resistant, oil-resistant polyethylene terephthalate laminate name tag, in which the adhesive polyolefin film (L3) includes a laminate film formed by extrusion-molding a resin formed of an adhesive polyethylene acrylate resin and a tackifier with a casting method at 250 to 300° C.

Fifth, there is provided a method of producing a transparent, heat-resistant, oil-resistant polyethylene terephthalate laminate name tag, in which the printed article (L4) has a weight loss rate of 3% or less after being kept in an air heating furnace at 150° C. for 10 minutes and has desired information on at least one surface of a polyester film substrate.

Sixth, there is provided a method of producing a transparent, heat-resistant, oil-resistant polyethylene terephthalate laminate name tag, in which the pouch films (P) are each formed by cutting the three-resin three-layered film (F) into predetermined dimensions, superimposing two three-resin three-layered films (F) in a manner that each of the adhesive polyolefin film (L3) layers faces each other, and welding at least one part of the resulting product by heating at 120 to 230° C.

Seventh, there is provided a method of producing a transparent, heat-resistant, oil-resistant polyethylene terephthalate laminate name tag, in which a laminate which is formed of the pouch films (P) and the printed article (L4) inserted therein is subjected to heat-welding treatment at 130 to 200° C. by being passed through a laminating machine.

Eighth, there is provided a method of producing a transparent, heat-resistant, oil-resistant polyethylene terephthalate laminate name tag, in which the transparent, heat-resistant, oil-resistant polyethylene terephthalate laminate name tag maintains a shape thereof without delamination or large deformation, being caused even after being immersed in a paraffin-based washing tank with a metal basket in which a metal parts to which a cutting lubricant is adhered are placed, at normal temperature to 70° C. for 5 to 10 minutes and subjected to a degreasing process in a vacuum furnace at 140 to 150° C. for 5 to 10 minutes.

### EFFECTS OF THE INVENTION

The laminated name tag formed of the heat-resistant, oil-resistant pouch film and the printed article of the present invention is useful as a heat-resistant, oil-resistant name tag “signs” in a wide variety of fields of part production such as automobile components, machinery industrial components, and electronic and electric components. In parts production, in view of environmental problems, the cleaning fluid for metal parts is shifting from an air pollution type of aromatic-based detergent (BTX) to a paraffin-based solvent causing less pollution. Paraffin-based solvents barely volatilize, and hence high temperatures and high vacuum are required in a drying process. Instructions, so-called “signs or KANBAN”, on which the production name, detailed specifications, process methods, washing methods, drying methods, storage methods, and preservation methods are printed in detail are transferred together with the parts, thereby requiring heat and oil resistance, non-expansion properties, and the ability to maintain shape in a high-temperature vacuum drying machine.

In particular, as a printed article serving as a signboard, natural paper printed with an aqueous ink-jet ink generally has a moisture of 6% or more is not preferred, Since this moisture expands in a high-temperature vacuum drying machine to greatly deform the transparent, heat-resistant, oil-resistant laminate name tag. It has been discovered for the first time with the present invention that as the printed article, an O-PET film printed with a laser printer is preferred.

The transparent, heat-resistant, oil-resistant laminate name tag of the present invention maintains the shape thereof without suffering delamination or a large deformation, even after undergoing the steps of: being immersed in a paraffin-based washing tank with metal parts to which a cutting lubricant is adhered, that are placed in a metal basket, at normal temperatures to 70° C. for 5 to 10 minutes; and being subjected to a degreasing process in a vacuum furnace at 140 to 150° C. for 5 to 10 minutes. On the other hand, a conventional laminating pouch film formed of a polyethylene adhesive or polypropylene adhesive cannot respond to those objects, and thus, the present invention is particularly useful.

### BEST MODE FOR CARRYING OUT THE INVENTION

### Transparent, Heat-Resistant, Stretched Polyester Film: L1

As a transparent, heat-resistant, stretched polyester film (L1), there can be used a biaxially stretched polyethylene terephthalate film having a thickness of 30 to 150 μm and a crystallinity index of 20% or more, because the biaxially stretched polyethylene terephthalate film is transparent and heat-resistant at 200° C. and is oil-resistant. The thickness of L1 is preferably 50, 75, or 100 μm based on the quality and cost thereof. When the thickness is 30 μm or less, heat deformation is likely to occur, and when the thickness is 150 μm or more, the cost becomes high.

[Heat-Resistant, Oil-Resistant Pet Resin and Film (L2)]

A heat-resistant, heat-welding PET resin (R) of the present invention can be produced by a homogeneous reaction at temperatures of 250° C. or higher of a mixture formed of (A) 100 parts by weight of a polyethylene terephthalate polyester, (B) 0.05 to 2 parts by weight of a polymer polyfunctional epoxy compound as a binder, in which a molecular weight of a skeleton resin is 1,000 to 300,000 and the skeleton resin contains 5 to 100 epoxy groups in the molecule, (C) 0.1 to 1 part by weight of a metal salt of an organic acid as a binding reaction catalyst, (D) 0 to 50 parts by weight of a polycondensate of ethylene glycol/cyclohexanedimethanol/terephthalic acid (PETG), and (E) 0 to 50 parts by weight of a polyester elastomer.

According to the present invention, at the time of producing a PET resin by adding a modifier formed of a binder and a catalyst to a PET polyester resin raw material having a comparatively low molecular weight and increasing the molecular weight and a melt viscosity by a reactive extrusion method, if polyfunctional epoxy binders of polymer solid and a mixture thereof are used, instead of a bifunctional to trifunctional (hexafunctional at most) low-molecular-weight liquid-mixed epoxy resin binder of the conventional method, a PET polyester resin can be obtained, which does not have by-products such as gelling and fish eyes (FE) even after a homogeneous binding reaction for a long period of time and is remarkably improved in molding processability compared to the resins of the conventional method.

(Pet Polyester as Component A)

As the component A, polyethylene terephthalate (PET), or polybutylene terephthalate (PBT), polyethylene-2,6-naphthalate (PEN), PETG, or a copolymer thereof is exemplified, and polyethylene terephthalate (PET) is particularly preferred.

Further, an intrinsic viscosity of component A is, when measured by dissolving component A into a 1,1,2,2-tetrachloroethane/phenol (1:1) mixed solvent at 25° C., preferably 0.60 dl/g or more and more preferably 0.70 dl/g or more. When the intrinsic viscosity is less than 0.60 dl/g, it is difficult to macromolecularize the resin even by the present invention, and the polyester resin to be obtained may not necessarily achieve excellent mechanical strength. The upper limit of the intrinsic viscosity is not particularly limited, and is generally 0.90 dl/g or less and preferably 0.80 dl/g or less, which is inexpensive.

In a case where a recycled product of polyester is used, intrinsic viscosity of the recycled product is represented by the intrinsic viscosity which a molded product of the recycled product generally has, and the intrinsic viscosity is generally about 0.60 to 0.80 dl/g and in particular about 0.65 to 0.75 dl/g. In a case where a molded product of the recycled polyester is used, the form of the molded product may be any of fiber, film, sheet, bottle, or other molded products. Further, the recycled product may contain a small amount of additives such as filler, pigment, and dye. In particular, PET bottles are preferable as a polyester raw material of the present invention, because the social environment for collecting and recycling PET bottles is being developed and besides, the polyester used for PET bottles has a suitable composition for reuse.

(Polymer Polyfunctional Epoxy Binder as Component B)

As the component B, a polymer polyfunctional epoxy compound in which a molecular weight of a skeleton resin is 1,000 to 300,000 and the skeleton resin contains 5 to 100 epoxy groups in the molecule can be used alone or two or more kinds thereof can be used in a mixture. Examples of commercially available products that can be used, in which an epoxy ring-containing glycidyl group is suspended on a polymeric resin like a pendant, include: “MODIPER” A series, “NOFALLOY” IE series, “BLEMMER”, “Falpack”, and “Marproof” series manufactured by NOF CORPORATION; “Epofriend” series manufactured by DAICEL CHEMICAL INDUSTRIES, LTD.; and “Bondfast” manufactured by Sumitomo Chemical Co., Ltd.

As the skeleton resin, acrylic resins are more preferred than the polyolefins (PP, PS, PE). This is because the solubility parameters of the resin are as follows: raw material PET: 10.7; an epoxy resin: 10.8; polymethyl acrylate: 10.2; polyethyl acrylate: 9.4; polypropylene (PP): 9.3; polyethyl methacrylate: 9.0; polystylene (PS): 8.9; and polyethylene (PE): 8.0, and the nearer the value, the better they mix with each other. It should be noted that when the polyolefins are each mixed even in an amount of 1 to 2%, they cause a film sheet of a PET resin to cloud, and hence the polyolefins are not suitable in cases where the molded product requires transparency.

The inventors of the present invention have used, in the conventional method, a compound which contains 2 to 3 or 4 to 6 epoxy groups in the molecule. As typical examples of a compound which contains 2 epoxy groups in the molecule, aliphatic ethylene glycol/diglycidyl ether (molecular weight: 174, epoxy equivalent: 135 g/eq., number of functional groups: 2 groups/molecule) and aromatic bisphenol A/diglycidyl ether (molecular weight: about 1,000, epoxy equivalent: 135 g/eq., number of functional groups: 2 groups/molecule) are given.

Further, as a typical example of a compound which contains 3 epoxy groups in the molecule on average, trimethylolpropane/triglydicyl ether (molecular weight: 288, epoxy equivalent: 150 g/eq., number of functional groups: 3 groups/molecule) are given. Still further, as typical examples of a polyfunctional compound which contains 3 or more epoxy groups in the molecule on average, epoxidized soybean oil (molecular weight: about 1,000, epoxy equivalent: 232 g/eq., number of functional groups: 4 groups/molecule) and epoxidized linseed oil (molecular weight: about 1,000, epoxy equivalent: 176 g/eq., number of functional groups: 6 groups/molecule) are given.

PET having an intrinsic viscosity (IV value) of 0.7 dl/g has a number average molecular weight of about 12,000, which is small in absolute molecular weight, and a molecular weight distribution Mw/Mn of 2 to 3, which is extremely small. Therefore, the molecular weight of products obtained by the binding reaction according to conventional methods has been 24,000 (bifunctional), 36,000 (trifunctional), or 72,000 (hexafunctional) at most. On the other hand, polyolefin resin has a number average molecular weight of 100,000 to 1,000,000, which is large, and a molecular weight distribution Mw/Mn of 5 to 20, which is extremely large. Metaphorically speaking, the molecular weight distribution of PET has a tower shape, which is narrow, while the molecular weight distribution of the polyolefin resin has a Mt. Fuji-shape, which is wide. Therefore, in regard to molding processability, the former is difficult to be molded and the latter is remarkably easy to mold.

A feature of the present invention is to provide a method of producing a polyethylene terephthalate graft copolymerized resin containing a reaction product which, like the polyolefin resin, has a large number average molecular weight of 100,000 to 1,000,000 and extremely large molecular weight distribution, by using a polymer polyfunctional epoxy compound alone or a mixture of two or more kinds thereof. Thus, the molding processability of PET polyester is remarkably facilitated just as that of the polyolefin resin.

Expansion control of the molecular weight distribution can be performed by using, as a polymer polyfunctional epoxy compound, a mixture containing 100% of a compound having 15 epoxy groups in the molecule, 50% of a compound having 30 epoxy groups in the molecule, or 25% of a compound having 60 epoxy groups in the molecule, for example, thereby producing a graft copolymer having a molecular weight of 180,000, 360,000, or 720,000 from the raw material PET having a molecular weight of 12,000 depending on the charging ratio and the blending amount of the compound. It should be noted that, although the polyolefin resin has a linear structure, the resin of the present invention is a graft copolymer, thus, a resin model differs from the polyolefin resin. The PET polyester generally has hydroxyl groups at both ends in many cases, but in some cases, the PET polyester has a carboxylic group at one end, which conducts coupling reaction with an epoxy group by using a catalyst. Accordingly, an image model of the product of the present invention has a state as follows: in the sea of the PET raw material having a molecular weight of 12,000, islands of chestnut-like graft copolymers each having a molecular weight of 180,000, 360,000, or 720,000 are dispersed depending on the charging ratio of each of the graft copolymers.

The blending amount of the polymer polyfunctional epoxy compound as the component B is 0.05 to 5 parts by weight with respect to 100 parts by weight of the PET polyester as the component A. A blending amount of 0.1 to 2 parts by weight is particularly preferable. When the blending amount is less than 0.1 part by weight, the increasing effect of the melt viscosity is insufficient and the molecular weight does not increase, which causes inadequate molding processability and therefore the basic physical properties and the mechanical properties of the molded product become poor. When the blending amount exceeds 5 parts by weight, an excess reaction occurs, yellow discoloration or coloring occurs, and by-products such as gelling and FE are generated.

In the present invention, in general, the melt tension and the tension viscosity of the PET polyester resin increase as the blending amount of the polymer polyfunctional epoxy compound increases, and in general, the molding processability is improved. Further, the crystallization rate of the PET polyester resin increases, because the polymer polyfunctional epoxy compound and a carboxylic acid metal salt catalyst each function as a “molecule-size crystal nucleus forming agent”. An effect of molding processability includes improvement in productivity owing to, for example, the injection molding cycle being shortened. In inflation film molding, bubbles become stable and unevenness in film thickness decreases. In T-die film molding, horizontal injection becomes possible, neck-in decreases, and the yield of the film improves. In sheet molding, draw down properties are improved and stable molding becomes possible.

In resin production using reactive extrusion, the melt viscosity of the raw material PET and that of the polymer polyfunctional epoxy solid are approximately the same, and hence they are well mixed with each other. Therefore, yellow discoloration or coloring and generation of by-products such as gelling and FE, which have been problems when using low-molecular-weight epoxy liquids according to conventional methods, are not caused any more.

(Coupling Reaction Catalyst as Component C)

The coupling reaction catalyst as component C is a catalyst including at least one or more kinds selected from the group consisting of (1) an organic acid salt of an alkali metal, a carbonate of an alkali metal, and a bicarbonate of an alkali metal, (2) an organic acid salt of an alkaline earth metal, (3) an organic acid salt of aluminum, zinc, or manganese, and (4) an organic acid salt of manganese and a carbonate of manganese. As the organic acid salt, a carboxylate, an acetate, or the like can be used, and a carboxylate is particularly preferable.

As the metal forming metal salts of carboxylic acid, alkali metals such as lithium, sodium, and potassium; and alkaline earth metals such as magnesium, calcium, strontium, and barium can be used.

The blending amount of the carboxylate as the binding reaction catalyst is 0.1 to 1 part by weight with respect to 100 parts by weight of the PET polyester as component A. The blending amount is particularly preferably 0.1 to 1 part by weight. When the blending amount is less than 0.1 parts by weight, the catalyst effect is small, and thus the reaction is not completed and the molecular weight may not increase sufficiently. When the blending amount exceeds 1 part by weight, gel generation or a rapid increase in the melt viscosity occurs due to a local reaction, which causes troubles inside an extrusion molding machine and the like.

(Polycondensate of Ethylene Glycol/Cyclohexanedimethanol/Terephthalic Acid as Component D)

The Component D is a noncrystalline copolyester resin of the polycondensate of ethylene glycol/cyclohexanedimethanol/terephthalic acid, and 0 to 50 parts by weight of the so-called PETG, such as the Eastar series manufactured by Eastman Chemical Company and Skygreen manufactured by Sunkyon Industries, can be used. Component D makes a heat-resistant, oil-resistant resin flexible and enhances adhesive force with another layer. The use amount of component D is preferably 5 to 40 parts by weight. It is not preferred that the use amount be 5 parts or less by weight, because the effects are small, and it is also not preferred that the use amount exceed 50 parts by weight, because the heat resistance of the heat-resistant, heat-welding resin is decreased and the heat shrinkage thereof occurs, which causes cost increases.

(Polyester Elastomer as Component E)

As component E, 0 to 50 parts by weight of a polyester type polyester elastomer such as the NUBELAN series manufactured by TEIJIN CHEMICALS LTD., PELPRENE series manufactured by TOYOBO CO., LTD., or Hytrel series manufactured by DU PONT-TORAY CO., LTD. can be used. The PET polyester elastomer manufactured by TEIJIN CHEMICALS LTD. is particularly preferable because it is low-priced and capable of making the film transparent. Further, the PRIMALLOY series manufactured by Mitsubishi Chemical Corporation has flexibility and adhesion-imparting effect, and can be preferably used. Component E simultaneously enhances the adhesive force between component E and the biaxially stretched PET film and the adhesive force between component E and the printed article (signs).

The use amount of component E is preferably 1 to 30 parts by weight and particularly preferably 5 to 20 parts by weight. It is not preferred that the use amount be 1 part or less by weight, because the effects are small, and it is also not preferred that the use amount exceed 50 parts by weight, because the heat resistance of the heat-resistant, heat-welding resin is decreased, which causes cost increases.

By the way, the cost ratio of the respective raw material components is as follows: A: recycled PET/new PET/D: PETG/E: polyester elastomer=100/200/400/1,500. Accordingly, economically, it is extremely important that the ratio of the components be selected by taking quality of the resin into consideration and that the cost ratio of the heat-resistant, heat-welding resin be in a range of 600 to 800.

(Blending Method and Coupling Reaction)

Next, a method of producing the heat-resistant, heat-welding PET resin of the present invention is described. A PET polyester with any appropriate form, such as general virgin chips, recycled flakes, granulated matter, powder, or chips can be used as component A. In general, it is preferred that the PET polyester as component A, PETG as component D, and the polyester elastomer as component E be dried.

The respective components are mixed in a mixing machine such as a tumbler or a Henschel mixer, and are supplied into a reactive extrusion apparatus. The temperature at which the mixture is heat-melted is desirably 250° C. (melting point of polyester) or higher and 300° C. or lower from the viewpoint of controlling the reaction. A temperature of 280° C. or lower is particularly preferable, and when the temperature exceeds 300° C., discoloration or thermal decomposition of the polyester may occur.

As a reaction apparatus for heat-melting the mixture, there can be used a uniaxial extruder, a biaxial extruder, a two stage extruder as a combination of the uniaxial extruder and the biaxial extruder, and the like. It should be noted that the reaction apparatus requires an extruder having a specific screw structure and a specific vacuum line. It is important that the optimal blending composition be selected by taking into consideration the number of steps included in a kneading process and the heating conditions.

[Adhesive Polyolefin Film: L3]

An adhesive polyolefin film (L3) can be used as a laminate film, which is formed by extrusion-molding a resin composition added with an adhesive polyethylene acrylate resin and a tackifier with a casting method at 250 to 300° C. As the adhesive polyethylene resin, there can be used commercially available resins such as the ET series and RB series of REXPEARL and EEA resins manufactured by Japan Polyethylene Corporation, NUC copolymer manufactured by UNIKA. LTD., and EVAFLEX manufactured by du PONT-MITSUI POLYCHEMICALS CO., LTD. As the tackifier, there can be used commercially available products such as a rosin tackifier manufactured by Arakawa Chemical Industries, Ltd. and a terpene phenol resin tackifier manufactured by YASUHARA CHEMICAL CO., LTD. The addition amount of the tackifier is 10 to 50% and preferably 20 to 30% with respect to the adhesive polyethylene resin such as an EEA resin.

Effects of using the adhesive polyolefin film (L3) are, in comparison with the case of a two-resin two-layered (L1/L2) film, in the following improvements: the heat-welding temperature of the pouch film can be lowered from about 180 to 200° C. to about 130° C.; and, at the time of completing the laminate name tag (signs) by inserting a printed article (L4) of PET film between three-resin three-layered films (F: L1/L2/L3) and heat-welding the resulting product by allowing it to pass through a laminating machine, the heat-welding temperature thereof can be lowered from about 180 to 200° C. to about 130 to 200° C. and preferably to about 150 to 180° C. Those improvements are seen as the effects of the adhesive polyolefin film (L3), because the upper limits of the temperature of commercially available laminating machines are 130° C. in a normal model, 150° C. in a specific model, and 160 to 180° C. in an extremely specific model, and the heat-resistant upper limit of the temperature of a heating roller made of silicone incorporated in a laminating machine is 180° C. Therefore, the use of the adhesive polyolefin film (L3) is an essential item of the present invention.

[Three-Resin Three-Layered (L1/L2/L3) Film: F]

The three-resin three-layered (L1/L2/L3) film (F) of the present invention can be produced by: extruding, from a T-die with a casting method at 250 to 300° C., on the biaxially stretched PET film (O-PET film: L1) having a crystallinity index of 20% or more, successively the heat-resistant, oil-resistant, adhesive PET resin and film (L2), and the adhesive polyolefin resin and film (L3); and molding the resulting product into a film having a width of 1,000 to 1,200 mm, for example.

It is beneficial to subject the O-PET film (L1) to corona treatment and further treat the O-PET film (L1) with a primer (AC) agent in order to enhance the adhesion with the heat-resistant, oil-resistant, adhesive PET resin of the present invention. Further, it is also beneficial to perform ozone treatment at the time of extrusion molding the heat-resistant, oil-resistant, adhesive PET resin.

The stretched PET film (O-PET film), which is uniaxially stretched or biaxially stretched, can be used as long as the film has a crystallinity index of 20% or more so that the film has heat resistance. In general, films each having a thickness of 10 to 250 μm are commercially available, and hence, they can be used easily. A biaxially stretched O-PET film is particularly preferable, because there is hardly any deformation or heat shrinkage in a high-temperature drying furnace. The thickness of a commercially available laminating pouch film is generally 100 μm, and the laminating machine models are manufactured and sold in accordance therewith. Therefore, in the present invention, the thickness of the O-PET film is preferably 30 to 100 μm and more preferably 50 to 75 μm, because a thick O-PET film is expensive. When the thickness of the O-PET film is 30 μm or less, creases are likely to occur at the time of passing through a laminating machine, and heat resistance of the laminate name tag decreases. On the other hand, when the thickness is 100 μm or more, contact failure occurs between the printed article and the pouch film at the time of laminating treatment due to insufficient heat conduction, and the laminate name tag becomes expensive, which reduces economic efficiency.

[Laminating Pouch Film: P]

A pouch film (P) is formed by cutting a three-resin three-layered film (F) into predetermined dimensions, into a width of 200 mm in the case of, for example, an envelope size in the present invention, and then being rolled into a roll. Subsequently, the two rolls are automatically fed so that the three-resin three-layered film (F) is superimposed on the other three-resin three-layered film (F) in a manner that each of the surfaces of the adhesive polyolefin films (L3) face each other. After heat welding one part 5 mm from the edge of one side of the two superimposed films (F) in a feed direction 2 to 5 mm wide at 120 to 200° C., the automatically fed films are guillotined into a length of 100 mm, for example, whereby the pouch film (P: 100 mm wide×200 mm long, one part sealed) is produced.

[Printed Article (L4)]

It is essential for a printed article (L4) to have heat and oil resistance and to have non-expansion properties and to be able to maintain shape in a high-temperature vacuum drying machine, for the following reasons: instructions on which the production name, detailed specifications, process methods, washing methods, drying methods, storage methods, and receive methods of metallic parts are printed in detail and inserted in the heat-resistant, oil-resistant pouch film (P) and laminated to thereby form a transparent, heat-resistant, oil-resistant laminate name tag (signs), and the laminate name tag is transferred through a washing process together with the parts. Therefore, it has become apparent in the present invention that the moisture content of the substrate of the printed article and the printing method (ink-jet printing with an aqueous ink is not suitable and laser printing with a dry pigment ink is suitable) is crucially important. The moisture content of the printed article substrate was determined from the weight loss rate of one piece of A4 paper after being kept in an air heating furnace of 150° C. for 10 minutes (about the same value was obtained also after 5 minutes, mainly attributed to vaporization of moisture).

In a prior application, printed paper, which was a natural high-quality paper printed thereon with an ink-jet ink, was used. However, in order to achieve an object of the present invention, thin paper (thickness: 85 μm) was suitable, medium-thickness paper (thickness: 100 μm, −6.4) was somewhat suitable, and thick paper (thickness: 130 μm), particularly thick paper (thickness: 150 μm, −5.9 to −6.2%), and thickest paper (thickness: 180 μm, −6.7%) were not suitable. The inventors of the present invention have found out, from a study made later, that printed paper, which is a natural high-quality paper printed thereon with an ink-jet ink, contains about 6% moisture as described above, and thus, the moisture expands inside the laminate name tag (signs) in a vacuum furnace of 150° C. and creating large deformation. Therefore, the inventors have found that the problems can be ameliorated by selecting a material such as thin coated paper or synthetic paper (synthetic resin film) which contains moisture in as small an amount as possible and barely suffers heat shrinkage at high temperatures as the substrate for a printed article (L4) of the present invention.

As a result, as the printed article (L4) of the present invention, there can preferably be used a printed article which has a weight loss rate after being kept in an air heating furnace of 150° C. for 10 minutes of 3% or less and barely suffers heat shrinkage, and in which desired information is printed on at least one surface or preferably on both surfaces of a stretched polyester film substrate by a laser printer. On the other hand, even in the case of using synthetic paper, polypropylene synthetic paper for both-surface ink-jet printing has high heat shrinkage rate, which is not suitable.

[Transparent, Heat-Resistant, Oil-Resistant Laminate Name Tag (Signs)]

A transparent, heat-resistant, oil-resistant laminate name tag (signs) of the present invention is produced by subjecting a laminate which is formed of pouch films (P) and a printed article (L4) inserted therein to heat-welding treatment at 130 to 200° C., preferably at 150 to 180° C. by being passed through a laminating machine.

The transparent, heat-resistant, oil-resistant laminate name tag can maintain a shape thereof without suffering delamination or a large deformation, even after undergoing the steps of: being immersed in a paraffin-based washing tank with metal parts to which a cutting lubricant is adhered, that are placed in a metal basket, at normal temperatures to 60° C. for 5 to 10 minutes; and being subjected to a degreasing process in a vacuum furnace at 140 to 150° C. for 5 minutes. In order to realize heat resistance and oil resistance at 150° C. or higher according to the present invention, laminators for high-temperature must be used, and those specific laminators are available comparatively easily and inexpensively in the market, and thus, the present invention can be realized comparatively easily.

### EXAMPLES

Hereinafter, the present invention is explained by way of examples and comparative examples. Note that the analytical instruments used for measurements of physical properties and measurement conditions are shown below.

(1) The measurement of molecular weights was performed by a GPC method.

SYSTEM-21 manufactured by Showa Denko K.K., column: (both at sample side and reference side) Shodex KF-606M (2 columns), solvent: hexafluoroisopropyl alcohol, column temperature: 40° C., flow rate: 0.6 ml/min, polymer concentration: 0.15 wt %, detector: Shodex RI-74, molecular weight conversion standard: PMMA (Shodex M-75), and injection volume: 20 μl.

(2) Melt flow rate (MFR) was measured in accordance with JIS K 6760, under the conditions of temperature 280° C. and load 2.16 kg.

(3) Intrinsic viscosity (IV value) was measured at 25° C. with a Cannon-Fenske viscometer by using a mixed solvent formed of equivalent weight of 1,1,2,2-tetrachloroethane and phenol.

(4) Measurement of DSC: DSC was measured with DSC220 manufactured by Seiko Instruments Inc. by using 5 to 15 mg of sample, under the conditions of nitrogen 50 ml/min and rate of temperature rise 10° C./min, 20 to 300° C.

(5) Heat sealing strength: The laminate of the laminated film of the present invention was cut into widths of 15 mm, the film surfaces thereof were superposed, and the resulting product was heat sealed for Kg/cm²×1 second from the back surfaces of the substrates with a heater at 100 to 200° C. Sealing strength was measured with TENSILON RTC-121C at a tensile rate of 300 mm/min.

(6) Delamination strength: The film/substrate of the present invention was cut into widths of 15 mm and one edge thereof was immersed in ethyl acetate solution, thereby measuring T-delamination strength between two layers detached from each other with TENSILON RTC-121C at a tensile rate of 300 mm/min.

(7) Measurement of mechanical physical properties: Tensile test of the film of the present invention was performed in accordance with JIS K 7113 by using TENSILON RTC-121C at a tensile rate of 50 mm/min.

[Production Example 1 of Resin Pellets R1 for Heat-Resistant, Oil-Resistant PET Polyester Film (L2)]

To 100 parts by weight of recycled PET bottle parison crushed product (component A, KYOEI INDUSTRY Co., Ltd., intrinsic viscosity: 0.783 dl/g, number average molecular weight Mn: 14,000, weight average molecular weight Mw: 34,000, MFR: 45 g/10 min, moisture content after hot-air drying at 120° C. for 12 hours: 150 ppm), 10 parts by weight of PETG (component D, Eastman Chemical Company, MFR: 110 g/10 min, moisture content after hot-air drying at 70° C. for 4 hours: 100 ppm), and 5 parts by weight of polyester elastomer (component E, TEIJIN CHEMICALS LTD., reddish brown PET rubber TRB-ELA, moisture content after hot-air drying at 120° C. for 4 hours: 120 ppm), the following were added: 0.80 part by weight of a mixture of epoxy polymer compound (component E; NOF CORPORATION; BLEMMER CP30S: molecular weight 9,000, number of epoxy groups 17 groups/molecule; BLEMMER CP50M: molecular weight 10,000, number of epoxy groups 32 groups/molecule; Marproof G01100: molecular weight 12,000, number of epoxy groups 71 groups/molecule; weight ratio 0.5:1:0.5); 0.20 parts by weight of mixed powder of lithium stearate, sodium stearate, and calcium stearate (weight ratio 25:25:50) as a reaction catalyst; 0.1 part by weight of IRGANOX B225 as a stabilizer; and 0.05 part by weight of liquid paraffin as a spreader. The mixture was mixed in a tumbler for 10 minutes.

A uniaxial extruder manufactured by Hoshi Plastics CORPORATION (screw diameter: 65 mmΦ, compression screw, equipped with mixing belt, L/D=30, rotational frequency: 100 rpm, 1-vent type) was used, the preset temperature of the screw and the dies of the extruder was set to be 240 to 280° C., and while vacuuming with a dry-type pump, the parison mixture was loaded into a hopper and was supplied at a predetermined speed by a feeder, to thereby perform reactive extrusion. 5 strands were extruded continuously from the dies into water to be cooled, and were cut with a rotating cutter, whereby transparent resin pellets were produced at the rate of 80 Kg/hour. About 500 Kg of the thus obtained heat-resistant, oil-resistant, adhesive resin pellets R1 (MFR: 25 g/10 min) was hot-air dried at 120° C. for 12 hours, and thereafter stored in a moisture-proof bag or a moisture-proof container.

[Production Example 2 of Resin Pellets R2 for Heat-Resistant, Oil-Resistant PET Polyester Film (L2)]

To 100 parts by weight of recycled PET bottle flake (component A, Kyoei Co., Ltd., intrinsic viscosity: 0.73 dl/g, number average molecular weight Mn: 12,000, weight average molecular weight Mw: 31,000, MFR: 60 g/10 min, moisture content after hot-air drying at 120° C. for 12 hours: 130 ppm), 50 parts by weight of PETG (component D, Sunkyon Industries, Skygreen S2008, MFR: 120 g/10 min, moisture content after hot-air drying at 70° C. for 4 hours: 120 ppm), and 5 parts by weight of polyester elastomer (component E, TEIJIN CHEMICALS LTD., reddish brown PET rubber TRB-ELA, moisture content after hot-air drying at 120° C. for 4 hours: 120 ppm), the following were added: 1.0 part by weight of epoxy polymer compound (component E, NOF CORPORATION, BLEMMER CP50M, molecular weight: 10,000, number of epoxy groups: 17 groups/molecule 32); 0.20 parts by weight of mixed powder of lithium stearate, sodium stearate, and calcium stearate (weight ratio 25:25:50) as a reaction catalyst; 0.1 part by weight of IRGANOX B225 as a stabilizer, and 0.05 part by weight of liquid paraffin as a spreader. The mixture was mixed in a tumbler for 10 minutes. A uniaxial extruder manufactured by Hoshi Plastics CORPORATION was used in a similar manner as in Production Example 1 to obtain about 200 Kg of heat-resistant, oil-resistant, adhesive resin pellet R2 (MFR: 23 g/10 min). The resin pellets R2 was then hot-air dried at 120° C. for 12 hours, and thereafter stored in a moisture-proof bag or a moisture-proof container.

[Production Examples 3 and 4 of Three-Resin Three-Layered Films F1 and F2 Obtained by Laminating Heat-Resistant, Oil-Resistant, Adhesive PET Resin Film L2 and Adhesive Polyethylene Resin Film L3 on Biaxially Stretched Pet Film L1]

Production Example 3 of three-resin three-layered film F1: Heat-resistant, oil-resistant, adhesive PET resin R1 of Production Example 1 was laminated on biaxially stretched PET film L1 (manufactured by UNITIKA. LTD., one surface subjected to corona treatment) having a thickness of 75 μm. 0.05 part by weight of calcium stearate was added as a lubricant to 100 parts by weight of adhesive resin pellet R1 and the mixture was mixed in a super mixer for 1 minute. An extrusion laminating apparatus was used, which has an uniaxial screw with an orifice diameter of 90 mm (compression ratio: 4.6 times), extrusion dies of 1,300 mm wide, interval adjustment of air gap at 140 mm, and a horizontally placed touch roll made of silicone rubber and cooling mat roll (cooled to 20° C. by a chiller).

Laminating operation was performed at a rolling speed of 50 to 60 m/min, under the conditions of preset temperature of a cylinder of the extruder of 270 to 290° C., screw rotational frequency of 50 to 100 rpm, die preset temperature of 280 to 290° C., mat roll temperature of 20° C., and ozone treatment, and in the case of the biaxially stretched PET film L1 having a thickness of 50 μm, the corona treatment, application of urethane primer, and drying were performed inline. As the AC agent of the primer, polyesterurethane Takeda AC-63/Colonate L manufactured by Nippon Polyurethane Industry Co., Ltd. was used. Thus, a transparent two-resin two-layered (L1/L2) laminate S1 formed of biaxially stretched PET film L1 having a thickness of 50 μm and heat-resistant, oil-resistant, adhesive resin film L2 having a thickness of 25 μm was obtained in a 150 m-roll having a width of 950 mm.

Next, a transparent three-resin three-layered laminate F1 (L1=75 μm/L2=25 μm/L3=30 μm, total thickness=130 μm) was obtained in a 100 m-roll having a width of 850 mm, by laminating a adhesive polyethylene resin (HIRODINE 7589 manufactured by YASUHARA CHEMICAL CO., LTD., EEA resin and tackifier) on the two-resin two-layered laminate S1 in a thickness of 30 μm, by the same operational method as above, except that the preset temperatures of the cylinder and the dies were changed to 100 to 290° C. and 250 to 270° C., respectively, and that the inline primer was excluded.

Production Example 4 of three-resin three-layered film F2: In this example, biaxially stretched PET film L1 (manufactured by UNITIKA. LTD., one surface subjected to corona treatment) having a thickness of 50 μm was used, and a transparent two-resin two-layered (L1/L2) laminate S2 was obtained in a 150 m-roll having a width of 950 mm, by about the same operational method as in Production Example 3 and by using heat-resistant, oil-resistant, adhesive resin pellets R2. Next, transparent three-resin three-layered laminate F2 (L1=50 μm/L2=25 μm/L3=30 μm, total thickness=105 μm) was obtained in a 100 m-roll having a width of 850 mm, by laminating a adhesive polyethylene resin (HIRODINE 7589 manufactured by YASUHARA CHEMICAL CO., LTD., EEA resin and tackifier) on the two-resin two-layered laminate S2 in a thickness of 25 μm, by the same operational method as in Production Example 3, except that the preset temperatures of the cylinder and the dies were changed to 100 to 290° C. and 250 to 270° C., respectively, and that the inline primer was excluded.

Laminate S1 and laminate S2 were each folded at 180°, and the heat sealing strength between the heat-resistant, oil-resistant, adhesive resin films (L2) of the present invention was measured. The heat sealing strength at 120 to 200° C. was 1,500 g or more/15 mm wide, which was practically sufficient. Further, the delamination strength between biaxially stretched PET film L1 and heat-resistant, oil-resistant, adhesive PET resin film L2 of the present invention, in both laminate S1 and laminate S2, was 200 g or more/15 mm wide, which was practically sufficient.

[Production Examples 5 and 6 of Laminating Pouch Films P1 and P2]

Production Example 5 of laminating pouch film P1: Transparent three-resin three-layered laminate F1 (L1=75 μm/L2=25 μm/L3=30 μm, total thickness=130 μm) in a 100 m-roll having a width of 850 mm was cut into 200 mm wide strips with a slitter, whereby four 100 m-rolls were obtained.

Next, two of those 100 m-rolls were automatically fed so that the three-resin three-layered film (F1) was superimposed on the other three-resin three-layered film (F1) in a manner that each of the surfaces of the adhesive polyolefin films (L3) faced each other. After heat welding one part 5 mm from the edge of one side of the two superimposed films (F1) in a feed direction 2 mm wide at 130 to 132° C., the automatically fed films were slit into a length of 180 mm, and finally guillotined in a width of 100 mm, whereby 500 bags of pouch films P1 (100 mm wide×180 mm long, one part sealed, total thickness of two films: 130×2 μm) were produced.

Production Example 6 of laminating pouch film P2: Transparent three-resin three-layered laminate F2 (L1=75 μm/L2=25 μm/L3=30 μm, total thickness=105 μm) in a 100 m-roll having a width of 850 mm was cut into 200 mm wide strips with a slitter, whereby four 100 m-rolls were obtained.

Next, two of those 100 m-rolls were automatically fed so that the three-resin three-layered film (F2) was superimposed on the other three-resin three-layered film (F2) in a manner that each of the surfaces of the adhesive polyolefin films (L3) faced each other. After heat welding one part 5 mm from the edge of one side of the two superimposed films (F2) in a feed direction 2 mm wide at 130 to 132° C., the automatically fed films were slit into a length of 180 mm, and finally guillotined in a width of 100 mm, whereby 500 bags of pouch films P1 (100 mm wide×180 mm long, one part sealed, total thickness of two films: 105×2 μm) were produced.

[Production Example of Transparent, Heat-Resistant, Oil-Resistant Laminate Name Tags (Signs) K1 and K2 Series from Pouch Films P1 and P2 and printed article L4]

Production Example of transparent, heat-resistant, oil-resistant laminate name tags (signs) K1 and K2 series from pouch film P1 and printed article L4: Various signs models of the transparent, heat-resistant, oil-resistant laminate name tag were produced on a trial basis by: inserting various printed articles L4 (dimensions: 85 mm wide×170 mm long) into pouch film P1 (L1=75 μm/L2=25 μm/L3=30 μm, total thickness=130 μm: K1 series) or pouch film P2 (L1=50 μm/L2=25 μm/L3=30 μm, total thickness=105 μm: K2 series); and performing laminating treatment by using a laminator (for ID card issuing business, 95 to 180° C., Lamipacker LPC1506) manufactured by FUJIPLA Inc. at a temperature range of 145 to 180° C. which was adjusted by dial. Note that the weight loss rates of the resulting products after being kept in an air heating furnace of 150° C. for 10 minutes are shown inside the brackets.

Various signs models were produced on a trial basis with laser printed articles obtained by using, as a substrate of the printed article L4 of the present invention, the following biaxially stretched PET films for laser printing: Krisper K2323 manufactured by TOYOBO CO., LTD. having thicknesses of 75 μm (−1.2%), 100 μm (−0.60%), and 125 μm (−0.98%); and Skyrol SW84G manufactured by SKC CORPORATION having thicknesses of 75 μm (−2.2%) and 100 μm (−1.2%). The suitable temperature of the laminating machine is 160 to 180° C. The K1 series which was thicker showed its suitability at the higher temperature side, and the K2 series which was thinner showed its suitability at the lower temperature side.

As a comparative example, a signs model was produced on a trial basis with a printed article of PP synthetic paper for ink-jet printing: YUPOJET manufactured by Yupo Corporation having a thickness of 245 μm (−2.0%). Further, signs models were trially produced on a trial basis with various printed articles of: coated paper for laser printing including color laser paper PPC-WAA4C manufactured by Office 24 having a thickness of 85 μm (−6.2%), color laser paper manufactured by Fuji Zerox having a thickness of 95 μm (−5.2%), semi-gloss, and gloss color laser paper manufactured by KOKUYO Co., Ltd. having thicknesses of 95 μm (−6.7%) and 110 μm (−6.5%), and waterproof oil-resistant paper POEM manufactured by KISHU PAPER Co., Ltd. having thicknesses of 100 μm (−6.4%) and 150 μm (−6.9%); and super waterproof paper for ink-jet printing including paper manufactured by General Supply Co., Ltd. having a thickness of 210 μm (−6.9%).

Still further, signs models were produced on a trial basis with various printed articles of high-quality paper for ink-jet printing, having thicknesses of 100 μm (−6.4%), 130 μm, 150 μm (−5.9% to −6.2%), and 180 μm (−6.7%).

### [Evaluation Example of Transparent, Heat-Resistant, Oil-Resistant Laminate Name Tag (Signs)]

It is an object that, in general, the transparent, heat-resistant, oil-resistant laminate name tag of the present invention maintains it's shape without suffering delamination or a large deformation, even after undergoing the steps of: being immersed in a paraffin-based washing tank with metal parts to which a cutting lubricant is adhered, that are placed in a metal basket, at normal temperatures to 70° C. for 5 to 10 minutes; and being subjected to a degreasing process in a vacuum furnace at 140 to 150° C. for 5 to 10 minutes.

As a simple evaluation test method, the following was performed. A signs model of the laminate name tag was immersed in paraffin-based washing oil (NS clean 200) manufactured by JAPAN ENERGY CORPORATION at 50 to 60° C. for 10 minutes. Next, the signboard model was placed horizontally on a stainless tray in an air heating furnace and heated at 145 to 150° C. for 5 minutes. Immediately after that, the resulting product was transferred into a transparent glass vacuum bottle having an internal volume of 5 L, the bottle was placed vertically, and the bottle was put into a vacuum by opening a cock at the upper portion of the bottle (attained vacuum degree after 1 minute was −101 KPa, −760 mmHg). This simple evaluation test method matched well with the test in the factory line, and thus, the practicability of the transparent, heat-resistant, oil-resistant laminate name tag (signs) of the present invention could be substantiated. For each of the substrates, the weight loss rate of printed articles and the results of the signs in the simple evaluation test method and in the factory line test are shown below.

The biaxially stretched PET film for laser printing as a substrate of the printed article L4 had small weight loss rate after being kept in an air heating furnace of 150° C. for 10 minutes of −0.60 to −2.9%, and all the signs models passed the simple evaluation test, and also passed the factory line test. It should be noted that the thick K1 series were superior to the thin K2 series in maintaining the shape thereof as a signs. According to another test, the shape maintenance of a further thicker signboard trial model of O-PET 100 μm (L1) was even more superior.

The PP synthetic paper for ink-jet printing of the comparative example had a small weight loss rate of −2.0%, but severe heat shrinkage occurred therein, and thus, the signs model failed the simple evaluation test and the factory line test. Further, coated paper for laser printing of the comparative example had large weight loss rates after being kept in an air heating furnace of 150° C. for 10 minutes of −5.2 to −6.9%, and many of the signs models failed the simple evaluation test and the factory line test. In comparison, the thinner substrates were more likely to be acceptable products.

In addition, high-quality paper for ink-jet printing of the comparative example had large weight loss rates of −5.9 to −6.7% after being kept in an air heating furnace of 150° C. for 10 minutes, and most of the signs models had failed the simple evaluation test and the factory line test.

### INDUSTRIAL APPLICABILITY

According to the present invention, a laminating pouch film having heat and oil resistance of 150° C. or higher is developed, and thus, a printed article can be inserted into the pouch film and the resulting product subjected to laminating treatment. Therefore, a path for the laminating pouch film to be used in the wide fields of automobile components, machinery industrial components, and electronic and electric components has been opened up.

What is claimed is:

1. A method of producing a transparent, heat-resistant, oil-resistant polyethylene terephthalate laminate name tag, comprising:
sandwiching a printed article (L4) forming a center layer between pouch films; and
welding the resulting product by heating, wherein:
the pouch films each comprise a three-resin three-layered film (F) formed of, from outside:
a first layer comprising a transparent, heat-resistant, stretched polyester film (L1);
a second layer comprising a heat-resistant, oil-resistant, adhesive polyester film (L2) formed of a heat-resistant, oil-resistant polyethylene terephthalate resin, which is obtained by a homogeneous reaction at a temperature of 250° C. or higher of a mixture formed of (A) 100 parts by weight of a polyethylene terephthalate polyester, (B) 0.05 to 2 parts by weight of a polymer polyfunctional epoxy compound as a binder, in which a molecular weight of a skeleton resin is 1,000 to 300,000 and the skeleton resin contains 5 to 100 epoxy groups in a molecule, (C) 0.1 to 1 part by weight of a metal salt of an organic acid as a binding reaction catalyst, (D) 0 to 50 parts by weight of a polycondensate of ethylene glycol/cyclohexanedimethanol/terephthalic acid (PETG), and (E) 0 to 50 parts by weight of a polyester elastomer; and
a third layer comprising an adhesive polyolefin film (L3); and
the pouch films are each formed by superimposing two three-resin three-layered films (F) in a manner that each of the layers (L3) face each other.

2. A method of producing a transparent, heat-resistant, oil-resistant polyethylene terephthalate laminate name tag according to claim 1,
wherein the transparent, heat-resistant, stretched polyester film (L1) comprises a biaxially stretched polyethylene terephthalate film having a thickness of 30 to 150 μm and a crystallinity index of 20% or more.

3. A method of producing a transparent, heat-resistant, oil-resistant polyethylene terephthalate laminate name tag according to claim 1,
wherein the heat-resistant, oil-resistant, adhesive polyester film (L2) comprises a laminate film formed by extrusion-molding a heat-resistant, oil-resistant polyethylene terephthalate resin with a casting method at 250 to 300° C.,
the heat-resistant, oil-resistant polyethylene terephthalate resin being obtained by a homogeneous reaction of a mixture with a reactive extrusion method at temperature of 250° C. to 300° C. and having MFR of 50 g/10 min or less in accordance with a JIS method at 280° C., under a load of 2.16 Kg.,
the mixture being formed of (A) 100 parts by weight of a recycled or new polyethylene terephthalate polyester, (B) 0.05 to 2 parts by weight of a polymer polyfunctional epoxy compound as a binder, in which a molecular weight of a skeleton resin is 1,000 to 300,000 and the skeleton resin contains 5 to 100 epoxy groups in a molecule, (C) 0.1 to 1 part by weight of a stearate of an alkali metal and an alkaline earth metal as a binding reaction catalyst, (D) 0 to 50 parts by weight of a polycondensate of ethylene glycol/cyclohexanedimethanol/terephthalic acid, and (E) 0 to 50 parts by weight of a polyester elastomer.

4. A method of producing a transparent, heat-resistant, oil-resistant polyethylene terephthalate laminate name tag according to claim 1,
wherein the adhesive polyolefin film (L3) comprises a laminate film formed by extrusion-molding a resin formed of an adhesive polyethylene acrylate resin and a tackifier with a casting method at 250 to 300° C.

5. A method of producing a transparent, heat-resistant, oil-resistant polyethylene terephthalate laminate name tag according to claim 1,
wherein the printed article (L4) has a weight loss rate of 3% or less after being kept in an air heating furnace of 150° C. for 10 minutes and has desired information on at least one surface of a polyester film substrate.

6. A method of producing a transparent, heat-resistant, oil-resistant polyethylene terephthalate laminate name tag according to claim 1,
wherein the pouch films (P) are each formed by cutting the three-resin three-layered film (F) into predetermined dimensions, superimposing two three-resin three-layered films (F) in a manner that each of the adhesive polyolefin film (L3) layers face each other, and welding at least one part of the resulting product by heating at 120 to 230° C.

7. A method of producing a transparent, heat-resistant, oil-resistant polyethylene terephthalate laminate name tag according to claim 1,
wherein the laminate which is formed of the pouch films (P) and the printed article (L4) inserted therein is subjected to heat-welding treatment at 130 to 200° C. by being passed through a laminating machine.

8. A method of producing a transparent, heat-resistant, oil-resistant polyethylene terephthalate laminate name tag according to claim 1,
wherein the transparent, heat-resistant, oil-resistant polyethylene terephthalate laminate name tag maintains a shape thereof without suffering delamination or a large deformation, even after undergoing the steps of: being immersed in a paraffin-based washing tank with metal parts to which a cutting lubricant is adhered, that are placed in a metal basket, at normal temperatures to 70° C. for 5 to 10 minutes; and being subjected to a degreasing process in a vacuum furnace at 140 to 150° C. for 5 to 10 minutes.
